(19) United States
(12) Patent Application Publication
(10) Pub. No.: US 2003/0064184 A1
(43) Pub. Date: Apr. 3, 2003

(54) Wheel

(76) Inventor: Lin Chia-Yen, Taipei (TW)

Correspondence Address: Donald C. Casey, Suite 100, 311 North Washington Street, Alexandria, VA, 22314, US

(21) Appl. No.: 09/968,896

(22) Filed: Oct. 3, 2001

(51) Int. Cl. B29D 23/00; B65D 1/00; F16L 1/00; B32B 3/10; B32B 1/08; B29D 22/00

(52) U.S. Cl. 428/35.7; 428/131

(57) ABSTRACT

A wheel having a polyurethane wheel body and granulated rubber embedded in the poly urethane wheel body.

### BACKGROUND OF THE INVENTION

The present invention relates to wheels and, more particularly, to such a wheel, which is molded from a compound mixture containing polyurethane and granulated rubber.

Regular wheels for skateboards, roller skates, kick scooters, and vehicles, such as bikes, motorcycles, cars, etc., commonly have the wheel body made either from polyurethane or rubber. A polyurethane wheel has the characteristics of high resilience and high abrasive resistance, however its ground gripping performance is less sufficient. When running over a wet area, the wheel may slip on the ground. On the contrary, a rubber wheel provides high ground gripping power, however its resilience and abrasive resistance is poor in comparison with polyurethane.

### SUMMARY OF THE INVENTION

1. The present invention has been accomplished under the circumstances in view. It is the main object of the present invention to provide a wheel, which has high resilience and abrasive resistance as well as high ground gripping performance. To achieve this and other objects of the present invention, the wheel comprises a polyurethane wheel body and granulated rubber embedded in the polyurethane wheel body.

### BRIEF DESCRIPTION OF THE DRAWINGS

FIG. 1 is a perspective view of a wheel constructed according to the present invention.

FIG. 2 is an elevational view of an alternate form of the wheel according to the present invention.

FIG. 3 is an elevational view of another alternate form of the wheel according to the present invention.

### DETAILED DESCRIPTION OF THE PREFERRED EMBODIMENT

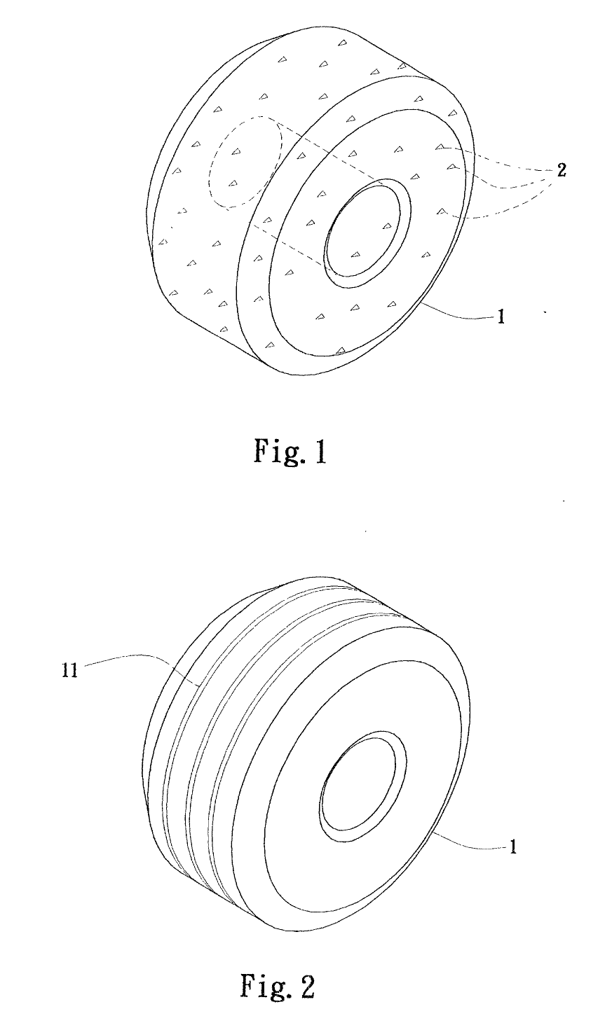

Referring to FIG. 1, a wheel is directly molded from a compound mixture containing fluid polyurethane and powdered/granulated rubber (either natural or synthetic). When well mixed, the compound mixture is filled into the cavity of a predetermined mold, and then molded into the desired finished product. The finished wheel 1 has granulated rubber 2 evenly distributed in the polyurethane body thereof. Therefore, the wheel 1 has the characteristics of polyurethane and rubber, i.e., the wheel has high resilience and abrasive resistance as well as high gripping performance.

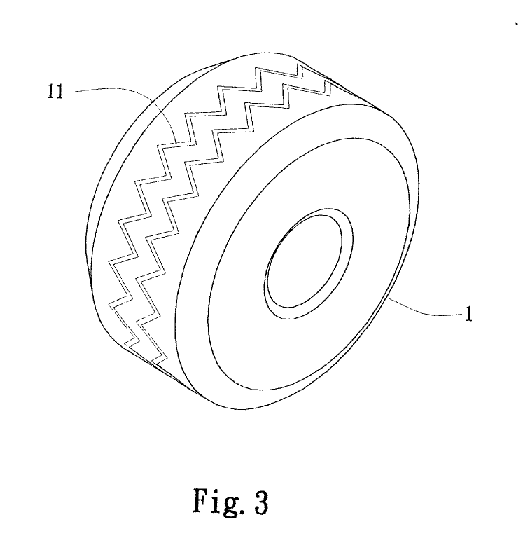

Referring to FIGS. 2 and 3, the wheel 1 has grooves 11 in the tread thereof. The grooves 11 can be made having any of a variety of patterns.

As indicated above, a wheel made according to the present invention comprises a polyurethane wheel body having embedded therein granulated rubber.

A prototype of wheel has been constructed with the features of FIGS. 1˜3. The wheel functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

2. A wheel comprising a polyurethane wheel body and granulated rubber embedded in said polyurethane wheel body.

3. The wheel as claimed in claim 1 wherein said granulated rubber is made from natural rubber.

4. The wheel as claimed in claim 1 wherein said granulated rubber is made from synthetic rubber.

5. The wheel as claimed in claim 1 wherein said wheel body has grooves in the tread thereof.
